(19) United States
(12) Patent Application Publication
(10) Pub. No.: US 2001/0027609 A1
(43) Pub. Date: Oct. 11, 2001

(54) Shaving system and foils

(75) Inventors: Charles C. Packham, Crowthorne (GB); Trevor John Crichton, Chesham (GB)

Correspondence Address: ERIC L. PRAHL, Fish & Richardson P.C., 225 Franklin Street, Boston, MA, 02110-2804, US

(73) Assignee: Braun GMBH

(21) Appl. No.: 09/826,720

(22) Filed: Apr. 5, 2001

Related U.S. Application Data
(62) Division of application No. 09/422,758, filed on Oct. 21, 1999.
Application No. 09/422,758 is a continuation of application No. PCT/EP98/02569, filed on Apr. 30, 1998.

(30) Foreign Application Priority Data
Apr. 30, 1997 (GB) 9708847.0
Apr. 30, 1997 (GB) 9708848.8

(51) Int. Cl. B26B 19/02

(52) U.S. Cl. 30/34.05; 30/43.92

(57) ABSTRACT

A shaving cutter (111) comprises a skin-engaging surface (116) having both a convex elliptic region (116a) and a hyperbolic region (116b). The elliptic region merges with the hyperbolic region along a parabolic transition region (117). Preferably, at least one of the surface regions is perforate. In addition, a concave parabolic skirt region (114) may depend from the hyperbolic region, while a convex parabolic skirt region (115) depends from the elliptic region. Methods of manufacturing the shaving cutter are also described.

This invention relates to shaving cutters, e.g. foils, to shaving systems, and to methods of electroforming a shaving cutter.

As explained in “VNR Concise Encyclopaedia of Mathematics” 2nd Edition (ISBN 0-442-20590-2) at pages 568 and 569, if the Gaussian curvature of a curved surface at a point P has the value k(P), three cases may be distinguished:

1. k(P)>0, when the point P is called elliptic;

2. k(P)<0, when the point P is called hyperbolic; and

3. k(P)=0, when the point P is called parabolic.

This formal division has a close connection with the shape of the surface. For example, on a torus, the points towards the inside are hyperbolic and the points towards the outside are elliptic. These two sets of points are separated from one another by two circles which consist of parabolic points.

An ellipsoid has only elliptic points, a saddle surface has only hyperbolic points and a circular cylinder has only parabolic points.

In this specification, for convenience a surface region containing only elliptic points will be called an elliptic surface region, a surface region containing only hyperbolic points will be called a hyperbolic surface region and a surface region containing only parabolic points will be called a parabolic surface region.

Conventional shaving foils for oscillatory dry shavers almost invariably provide only parabolic surfaces. An exception is JP-A-7-646 (Japanese Patent Application No. 5-143093) which describes a foil having an elliptic surface. A base member is formed by applying resist to a flat sheet of metal, patterning the resist and then deforming the metal sheet by a drawing process to form an elliptic surface. The method is limited by the fact that excessive deformation of the initially flat sheet could cause cracking of the resist layer.

The present applicant's own application WO093/19887 describes methods of manufacturing perforated foils for shavers in which a thin metal foil, supported on a flexible electrically insulating substrate, is patterned and subsequently thickened by electro-deposition or electroless methods. One method described for patterning the metal film involves coating the film with an electrophoretic photoresist before exposing and developing the photoresist using a photographic artwork of the pattern of an electric shaver foil. The metal exposed after development of the photoresist is stripped in a solution of sulphuric acid and hydrogen peroxide. The remaining photoresist is then stripped to leave the flexible insulating substrate carrying the metal pattern. The document contains no suggestion of applying this technique to the electroforming of complex three-dimensional shapes.

In this specification, the expression “shaving cutter” is used to designate a foil-like cutter whether or not it is thin enough to qualify as a foil.

Although the surface regions of the human body which are habitually shaved are generally curved and uneven, the known shaving systems are not optimised for curved surfaces.

An object of the invention is to provide a shaving cutter, e.g. a foil, and a shaving system better adapted to shaving curved parts of the human body.

According to a first aspect of the invention, there is provided a shaving cutter comprising a skin-engaging surface which has both a convex elliptic region and a hyperbolic region.

Preferably, the elliptic region merges smoothly with the hyperbolic region.

In one embodiment, a concave parabolic skirt region depends from the hyperbolic region and a convex parabolic skirt region depends from the elliptic region. Preferably, the concave and convex skirt regions are concentric.

The cutter may further be provided with a pair of convex elliptic end cheeks each merging smoothly with the elliptic and hyperbolic regions.

According to a second aspect of the invention, there is provided a shaving cutter having a skin engaging surface which offers a convex first region which is parabolic or elliptic, a second region which is parabolic or hyperbolic, and first and second convex elliptic end zones merging smoothly with the first and second regions.

A respective skirt region may depend from each of the first and second regions.

In any of the above embodiments, the first and second regions are preferably perforate. Where the skirt regions are provided, these may also be perforate. If desired, the skirt regions may be provided with elongate hair capture slots.

According to a third aspect of the invention, there is provided a shaving cutter comprising:

first curved skin-engaging surface region;

a second curved skin-engaging surface region; and

the second surface region merging seamlessly with the first surface region;

there existing a cross-sectional plane intersecting the first surface region along a first curved line on which the first surface region is concave with a first radius of curvature and intersecting the second surface region along a second curved line on which the second surface region is convex with a second radius of curvature larger than the first radius of curvature.

According to a fourth aspect of the invention, there is provided a shaving cutter comprising:

a first surface region having two orthogonal planes of curvature, and being concave in one plane;

a second surface region having two orthogonal planes of curvature, and being convex in both planes; and

the first surface region merging seamlessly with the second surface region.

According to a fifth aspect of the invention, there is provided a shaving system comprising an outer cutter according to said first, second, third or fourth aspect, an undercutter conforming with the outer cutter and mounted for oscillatory movement beneath the outer cutter; and drive means for imparting said oscillatory movement to the undercutter.

According to a sixth aspect of the invention, there is provided a method of producing an electroformed shaving cutter in which:

a) a coating of electrophoretic photoresist is applied to a substrate having an electrically conductive surface by passing an electrical current therethrough, the surface having non-zero Gaussian curvature;

b) the photoresist is exposed to a suitable source of electromagnetic radiation through a mask whose shape conforms closely to that of the substrate;

c) the photoresist is developed; and

d) a metallic layer is electrodeposited onto the conductive surface regions of the substrate not coated with the photoresist.

For a better understanding of the invention and to show how the same may be carried into effect, reference will now be made by way of example to the accompanying drawings in which:

FIG. 1 shows schematically an isometric view of a shaver foil curved in multiple dimensions;

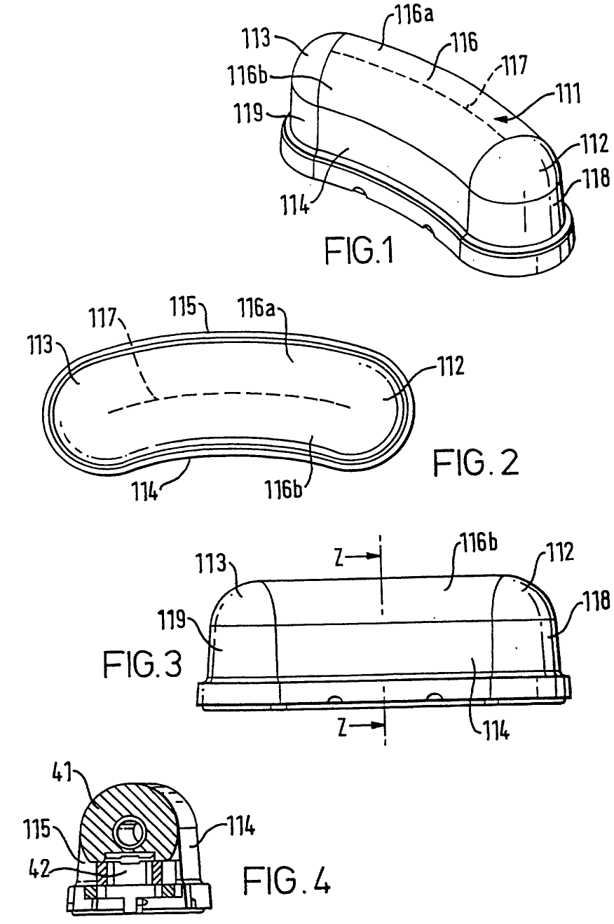

FIG. 2 shows a plan view of the shaver foil of FIG. 1;

FIG. 3 shows a side view of the shaver foil of FIGS. 1 and 2;

FIG. 4 shows a sectional view taken on the line Z-Z of FIG. 3;

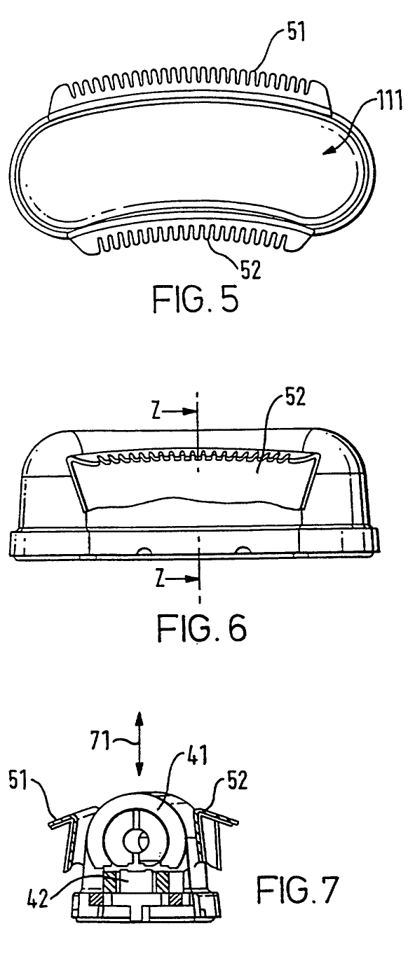

FIG. 5 shows a plan view of the shaver foil of FIGS. 1 to 3 provided with a trimmer on each of the curved side flanks of the foil;

FIG. 6 shows a side view of the shaver foil of FIG. 5;

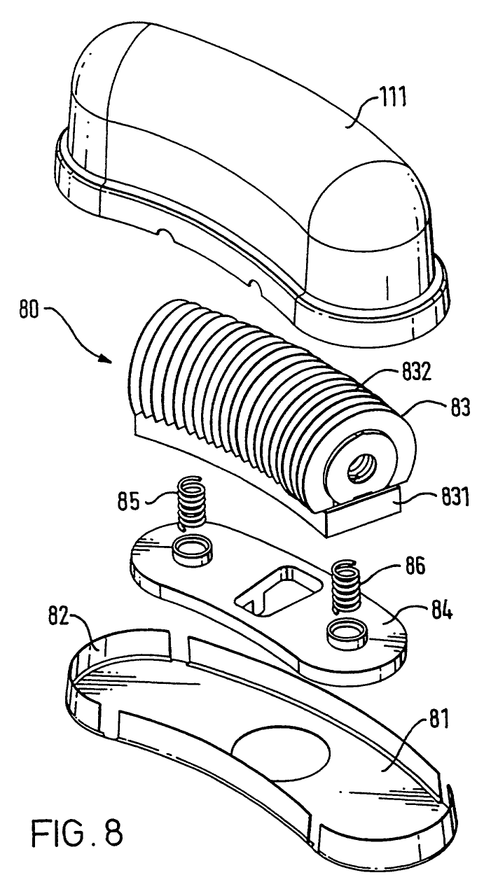

FIG. 7 shows a sectional view taken on the line Z-Z of FIG. 6;

FIG. 8 is an isometric exploded view of a shaver head incorporating the-curved shaver foil of FIGS. 1 to 3;

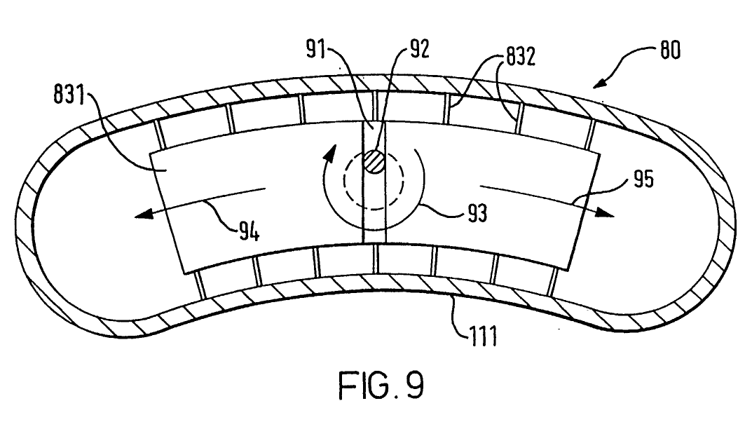

FIG. 9 is a bottom view of the shaver head of FIG. 8 showing the undercutter movement;

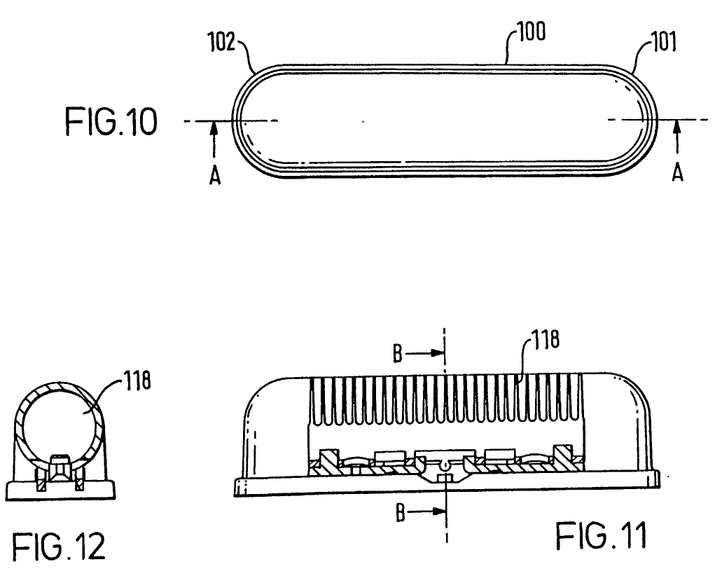

FIG. 10 shows a straight shaver foil having curved end flanks;

FIG. 11 shows a longitudinal sectional view taken on the line A-A of FIG. 10;

FIG. 12 shows a cross-sectional view taken on the line B-B of FIG. 11;

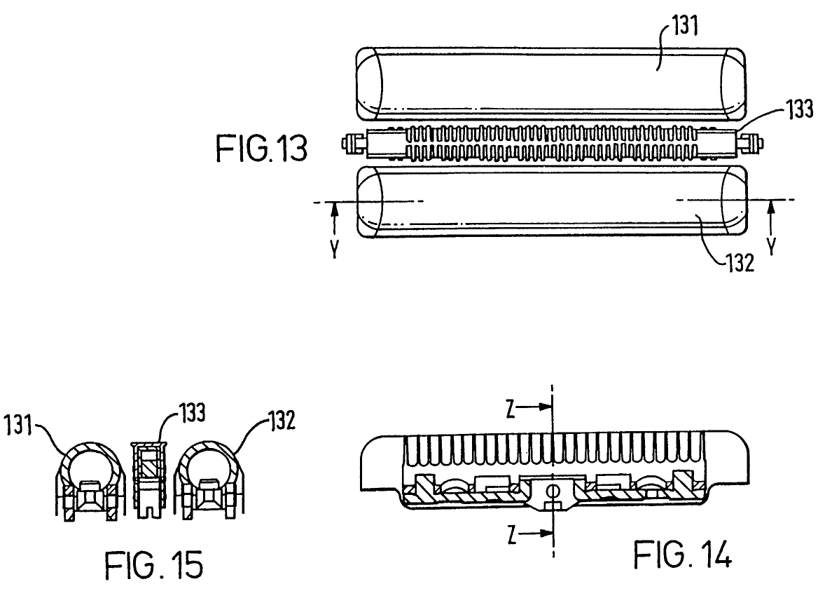

FIG. 13 shows a triple-headed shaver head design in which each of the shaver units is straight;

FIG. 14 shows a longitudinal sectional view taken on the line Y-Y of FIG. 13;

FIG. 15 shows a cross-sectional view taken on the line Z-Z of FIG. 14;

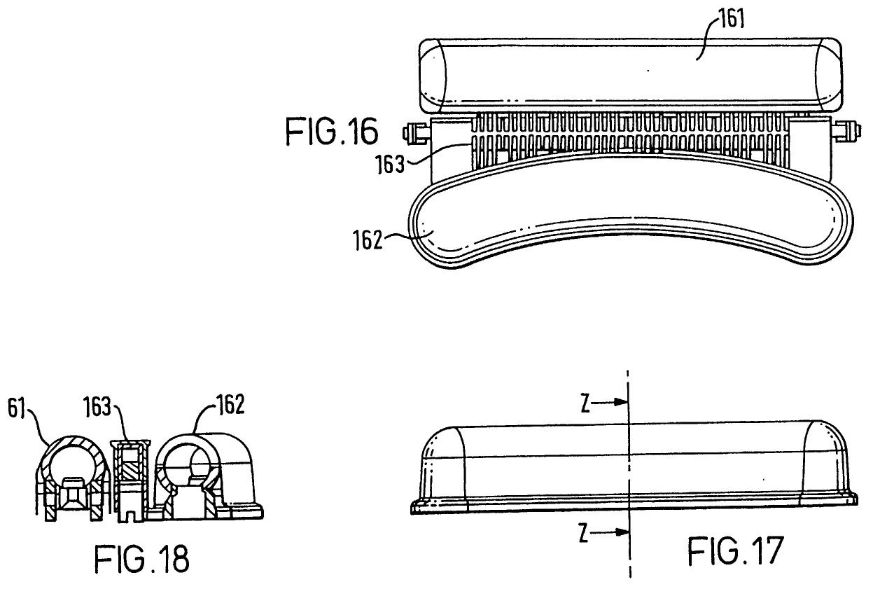

FIG. 16 shows a shaver head having three shaver units, one of which is curved;

FIG. 17 shows a side view of the shaver head of FIG. 16;

FIG. 18 shows a sectional view on the line Z-Z of FIG. 17;

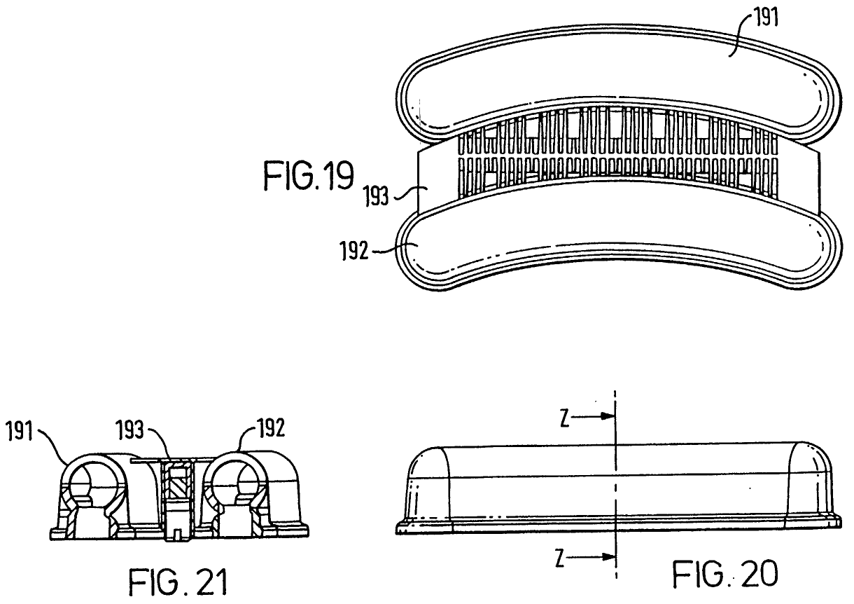

FIG. 19 shows a further shaver head having three shaving units, two of which are curved;

FIG. 20 shows a side view of the shaver head of FIG. 19;

FIG. 21 shows a cross-sectional view along the line Z-Z of FIG. 20;

FIG. 22 shows an exploded view of another shaver foil according to a further embodiment of the invention;

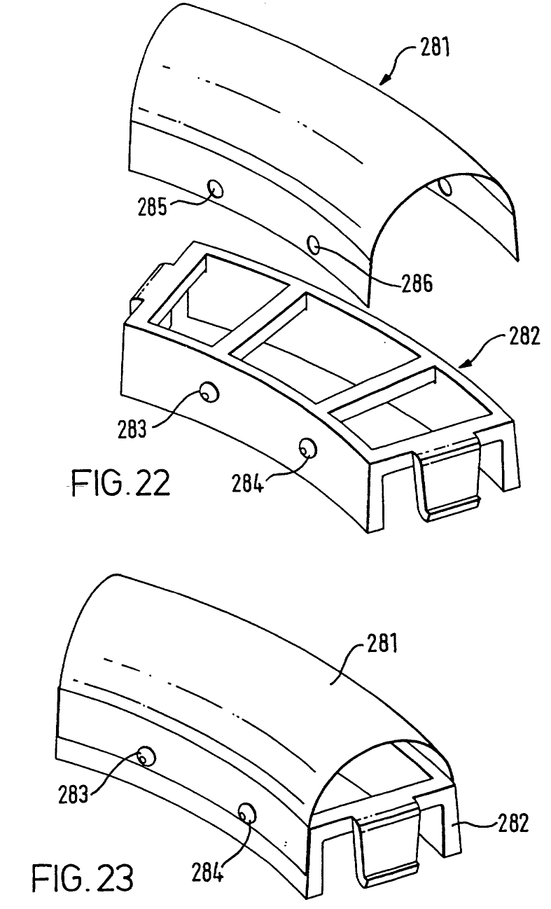

FIG. 23 shows an assembled isometric view of the shaver foil of FIG. 22;

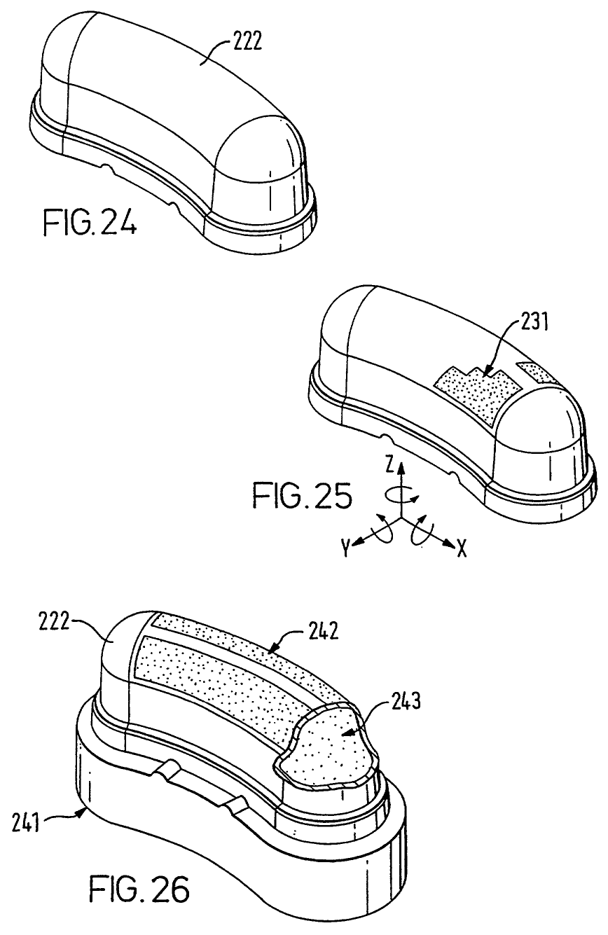

FIGS. 24 to 26 show three steps in a foil mask manufacturing process, in which FIG. 24 shows a shaped mandrel, FIG. 25 shows etching of a required foil pattern onto the mandrel of FIG. 24, and FIG. 26 shows the step of electroforming a mask onto the mandrel;

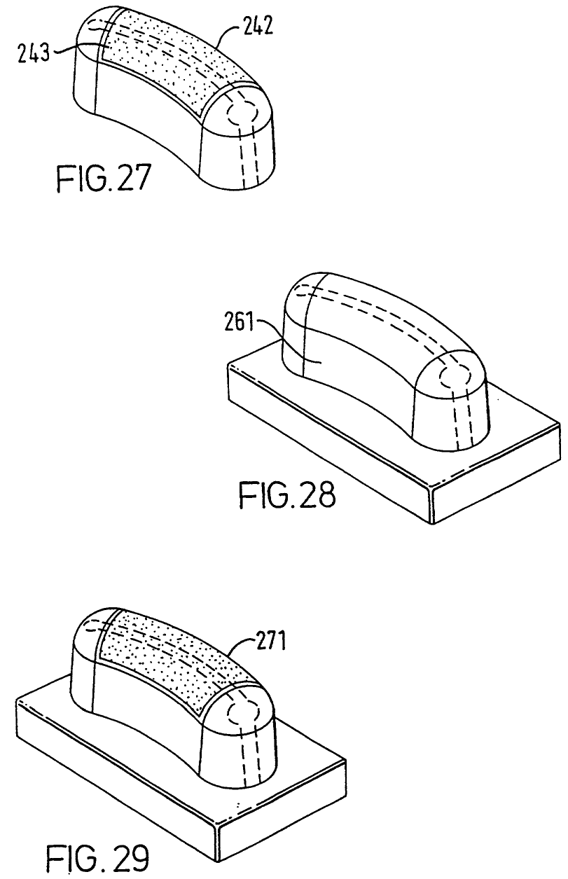

FIG. 27 shows a perspective view of a foil mask formed as shown in FIG. 26;

FIG. 28 shows an isometric view of a mandrel for use in forming the shaver foil of FIGS. 1 and 2;

FIG. 29 shows an isometric view of the mandrel of FIG. 28 with the electroformed article;

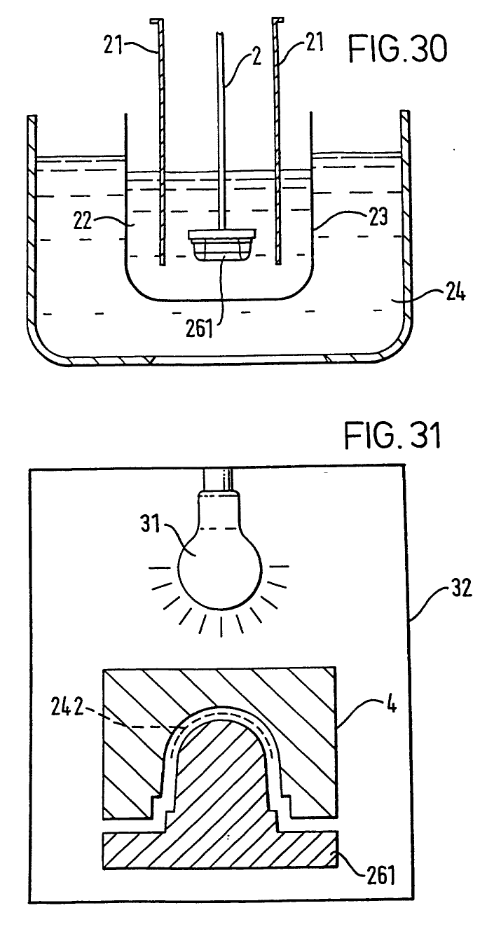

FIG. 30 shows apparatus for coating the mandrel of FIG. 28 with photoresist;

FIG. 31 shows schematically apparatus for exposing photoresist through the mask;

FIG. 32 shows apparatus for developing the photoresist; and

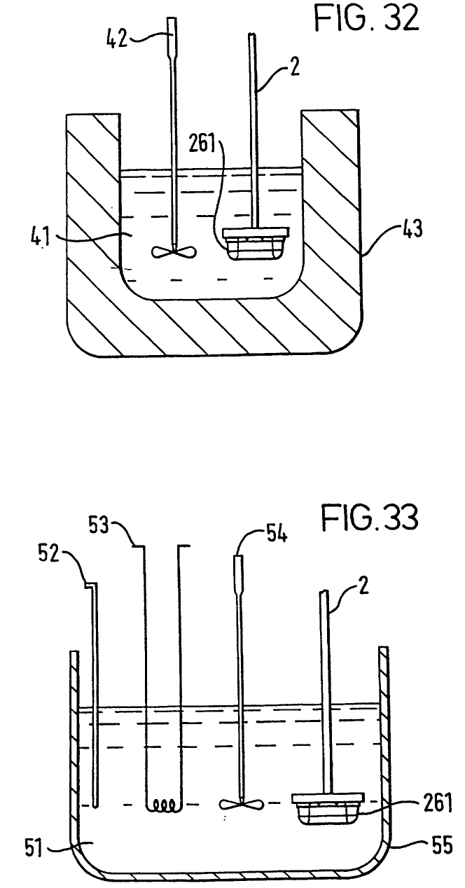

FIG. 33 is a schematic diagram of apparatus for electrodepositing a metallic layer onto exposed portions of the mandrel.

It has now been recognised that producing a shaver foil in a curved “banana shape” may increase the effectiveness of shaving, particularly curved parts of the human body.

The advantage of the “banana shape” is that the shaver foil is curved along its length as well as having both concave and convex faces which can be used to shave different contours of the human body, especially the underarm and leg regions.

More exactly, the shape provides a contour of continually varying surface curvature which provides planar, concave and convex shaving surfaces, thus offering an improved ability to match the contours of the body, especially in difficult areas such as underarm, legs, neck, jawbone and upper lip, and giving an improved shaving performance.

Speaking mathematically, it may be said that the foil possesses a first region where the points of the surface are elliptic and a second region where the points of the surface are hyperbolic.

The concave and convex nature of the surfaces enable the foil aperture geometry to be optimised locally for specific areas of the body or face.

The foil may also be provided with closed “wrap around” end cheeks which offer an improvement in shaving comfort, whether or not the foil has the curved “banana shape”.

Referring now to FIGS. 1 to 3, a banana shaped foil 111 is illustrated having closed convex elliptic end cheeks 112 and 113.

As shown in FIG. 1, the foil 111 includes a top surface 116, which is notionally divided by a line 117 into a first region 116a and a second region 116b. All points in the first region 116a are elliptic, whereas all points in the second region 116b are hyperbolic. The two regions 116a and 116b merge smoothly and seamlessly together along a line of parabolic points coincident with line 117.

A convex first side skirt 115 depends from and merges smoothly and seamlessly with the first region 116a, whereas a concave second side skirt 114 depends from and merges smoothly and seamlessly with the second region 116b.

The points of the first and second side skirts will be parabolic. Parabolic end skirts 118 and 119 merge smoothly and seamlessly with respective end cheeks 112 and 113 and with the side skirts 114 and 115 which are thus linked together.

The top surface 116 will be perforated with non-elongate apertures of the size conventionally used in shaver foils, e.g. 400-800 mm diameter. The concentric concave and convex side skirts 114 and 115 may also be provided with hair receiving apertures of the conventional size. However, they may also be provided with elongate hair capture slots for improved capture of longer hairs. Such elongate slots may typically have dimensions 2000 mm(maximum)×200 mm (minimum). The foil is manufactured by electroforming in one piece and is open at its base. By virtue of its shape, the foil has an arcuate longitudinal centre line, like a banana, and may be a sector of a toroid.

Where a toroidal sector is used, the circular centre line may have a radius of 50 mm. The body of the toroid may conveniently have a diameter of about 12 mm for a single foil device. These dimensions give an outer radius of the toroid of 56 mm. This outer radius should not be less than about 20 mm.

FIG. 4 shows a cross-sectional view through the foil, enabling the curved undercutter 41 and its drive arrangement 42 to be seen. These items will be described in more detail with reference to FIG. 8 and FIG. 9.

FIG. 5 shows how the curved foil 111 may be provided with a curved trimmer 51 on its convex side skirt and a further curved trimmer on its concave side skirt. The trimmer 52 on the concave skirt is more clearly visible in the side view of FIG. 6. Reference to FIG. 7 shows a cross-sectional view both through the foil, the undercutter 41 and the two trimmers 51 and 52. As schematically illustrated in FIG. 7, the trimmers 51 and 52 are extensible and retractable in the direction of the arrow 71 in a manner known per se.

FIG. 8 shows an exploded isometric view of the components of the shaver head shown in FIGS. 1 to 4. The foil 111 is received on and supported by a base plate 81 having an upstanding side wall 82. Within the foil is provided an arcuate undercutter 83 mounted on an undercut base plate 84 by respective coil springs 85 and 86. Each of the base plates 81 and 84 has a central aperture through which a drive pin extends to engage with the undercutter 83 and provide the required oscillatory motion.

The way in which the drive motion is achieved is better shown in FIG. 9. FIG. 9 shows a cross-sectional view through the shaver head 80 of FIG. 8. As shown, the curved undercutter 83 has blades 832 mounted on the base plate 831, and a drive slot 91 extends transversely through the base plate 831. A cam drive pin 92 engages the drive slot and caused to rotate in the manner shown by the arrow 93, thus causing reciprocation of the carrier 831 and undercutter in the direction of arrows 94 and 95.

FIGS. 10 to 12 show a modified embodiment of the invention including a straight shaving foil 100 having a parabolic shaving surface and closed elliptic end cheeks 101, 102. FIG. 11 shows a longitudinal sectional view taken along line A-A of FIG. 10. The view of FIG. 11 shows the undercutter 118, which is constructed in a substantially conventional way. FIG. 12 is a cross-section taken along line B-B of FIG. 11.

FIGS. 13 to 15 shows a shaving head having three shaving units 131, 132 and 133. Apart from possibly being of smaller diameter, each of the shaving units 131, 132 is constructed according to the design shown in FIGS. 10 to 12, whereas the central shaving unit 133 is a long hair cutter of known design. The shaving units 131 and 132 will normally be constructed for shaving short hairs.

FIGS. 16 to 18 show a further shaving system comprising three shaving units 161, 162 and 163. Shaving unit 161 is constructed according to the design of FIGS. 10 to 12, whereas shaving unit 162 is constructed according to the design shown in FIGS. 1 to 4, 8 and 9. Each of shaving units 161 and 162 is designed for shaving relatively short hairs. The central shaving unit 163 is however designed for cutting longer hairs. The cutter 163 differs from known cutters for longer hair in that the blades of the outer cutter of the unit are elongated towards each end in order to conform to the geometry of the curved short hair unit 162. The undercutter will however be driven to reciprocate linearly.

FIGS. 19 to 21 show a further embodiment including three shaving units, in which the two outer units 191 and 192 are each constructed according to the design shown in FIGS. 1 to 4, 8 and 9 and the central unit 193, for shaving longer hairs, has the shape of its outer cutter adapted to conform with the shape of the two short hair cutters 191 and 192. Again, the undercutter of unit 193 will be driven to reciprocate linearly, although an arcuate undercutter and movement on an arcuate path would also be possible.

FIG. 22 and 23 show a foil 281 which represents a modification of the foil of FIGS. 1 to 4 in which the end cheeks 112 and 113 are omitted, so that the foil 281 has open ends. This results in somewhat reduced structural rigidity. Accordingly, the foil is mounted on a frame 282 of synthetic plastics material having lateral lugs 283, 284 for engagement in securing apertures 285, 286 on the side skirts of the foil 281. It should be noted that although the foils described above are shown to have separate side skirts 114, 115, top region 116 and (where provided) end regions 112, 113, it is not essential for the side skirts 114, 115 to be distinct from the top region 116. It would equally be possible for the foil to be semicircular in cross-sections perpendicular to the longitudinal centre line.

Any of the shaped foils shown in FIGS. 1 to 23 may be constructed using an electroforming method which will now be described with reference to FIGS. 24 to 33.

The electroformed shaving foil is prepared by the following steps:

(a) a coating of electrophoretic photoresist is applied to a shaped substrate such as mandrel 261 of FIG. 28 having an electrically conductive surface of non-zero Gaussian curvature by passing an electrical current therethrough using the apparatus of FIG. 30;

(b) the photoresist is exposed to a suitable source of electromagnetic radiation, e.g. using the apparatus of FIG. 31 through a mask 242 shown in more detail in FIG. 27 and being of a shape to conform closely to that of the mandrel;

(c) the photoresist is then developed, e.g. using the apparatus of FIG. 32; and

(d) a metallic layer is electrodeposited onto conductive surface regions of the mandrel not coated with photoresist, e.g. using the apparatus of FIG. 33.

It has previously been difficult to electroform complicated surfaces having non-zero Gaussian curvature, although attempts have been made to use photolithography to expose a photoresist through a photo-imaging mask. However, conventional photoresists are usually applied as a liquid and therefore allow little or no control over the localised continuity of the photoresist. Whilst this may be satisfactory on a two-dimensional, flat surface, it causes difficulties if the photoresist is applied to a complex three-dimensional shape. Current dry film photoresist is not suited to application onto complex shaped surfaces.

This problem can be addressed by the use of an electrophoretic photoresist. Such a resist can be applied to a mandrel by the passage of electrical current. This not only causes the photoresist to adhere firmly to the substrate, but also produces a uniform thickness. Since the photoresist is non-conductive, the thickness is self-limiting. Thus, when the required thickness is achieved, the passage of electrical current ceases and the deposition process is arrested. The thickness may nevertheless be controlled by adjustment of solution temperature, current density, voltage and deposition time. Such photoresists thus have the advantage of coating the whole mandrel with a film of uniform thickness irrespective of the shape of the mandrel.

Electrophoretic photoresists can be applied to substrates by the passage of electrical current between two electrodes immersed in the photoresist solution. One of the electrodes is the substrate to be coated and this may be either anodic or cathodic. The thickness and continuity of the photoresist film are affected by the length of time the voltage is applied. If this is too long, the film may become porous because of the evolution of gas bubbles, but if the time is too short the film may not be fully formed and may therefore again be porous. However, if the photoresist is correctly deposited it offers a pore-free coating of uniform thickness with improved adhesion over conventional photoresists.

Referring now to the drawings in more detail, FIG. 30 shows a three-dimensional mandrel 261 supported by an electrically conductive rod 2. FIG. 31 shows the mandrel 261, a mask 242, and a transparent cap 4.

The three-dimensional mandrel 261 is precisely machined from stainless steel to a required shape, which may be a complex shape curving in 2 or 3 dimensions. The surfaces onto which an electroform is to be deposited are polished to remove any surface blemishes. Brass or another suitable material could alternatively be used for the mandrel. It may also be made of plastics material provided with an electrically conductive surface coating, e.g. a thin silver coating.

The mask 242 may be manufactured from copper or any other suitable pliable metal, e.g. silver, by electroforming as will be described hereinafter. Alternatively, the mask may be made by vacuum-forming a polyester layer over a suitable mandrel. The cap 4, preferably of perspex, has an internal cavity precisely matching the shape of the mandrel 261 for receiving the mask during the exposure step which will be described hereinafter.

One process of manufacturing an electroformed foil will now be outlined with reference to FIGS. 30 to 33.

Both anodic and cathodic electrophoretic photoresists are available. Here, it is preferred to coat the shaped surface of the mandrel 261 cathodically with an electrophoretic photoresist, e.g. DV-191™ manufactured by LVH Coatings Ltd. of Coleshill, Birmingham, U.K. To ensure good adhesion of the photoresist to the mandrel, suitable pre-treatment steps are used, using, for example, acid cleaner and rinsing agent.

The photoresist is then applied using the apparatus of FIG. 30. The mandrel 261, connected as cathode, and two anodes 21 are immersed in the electrophoretic photoresist 22 in a tank 23, which is held in a water bath 24.

It will be appreciated that storage of the photoresist and all operations following application of the photoresist to the substrate must be performed in subdued lighting, because the photoresist is light-sensitive. The coated mandrel is then thoroughly rinsed with rinsing agent and dried.

After the photoresist has been dried and allowed to cool, the preformed copper or polyester mask 242, retained in the cap 4, is then placed over the mandrel 261 as shown in FIG. 31. The assembly is processed by exposure to suitable radiation, e.g. ultraviolet light from source 31 in a light box 32 for sufficient time for the photoresist to be fully exposed. It may be required that the mandrel is inverted and re-exposed if the light box and mandrel designs do not allow the whole desired area to be exposed to radiation at the same time.

After the exposure steps, the mask and cap are removed from the mandrel. The photoresist is then developed as shown in FIG. 32 to produce a detailed negative photoresist image of the mask on the three-dimensional mandrel. After development, the mandrel is again rinsed and then cured at an elevated temperature. Curing can also be achieved by further exposure to a suitable electromagnetic radiation source.

Following developing of the photoresist all subsequent operations can be carried out in normal lighting.

The mandrel with its developed layer of photoresist must be pre-treated, prior to electroforming, to ensure that the subsequently deposited nickel layer is sound and to ensure that the nickel both fully conforms to the pattern imparted by the photoresist and yet can readily be parted from the mandrel. Ease of release can be effected by a surface passivation treatment e.g. using dichromate or other oxidising agent, dip or electrolytic pre-treatment.

Following the pre-treatment the metal layer is electroformed onto the mandrel using a suitable electrolyte 51 as shown in FIG. 33.

The manufacture of the foil mask will now be described with reference to the steps shown in FIGS. 24, 25 and 26.

It should be noted that if it is desired to produce an aperture of predetermined dimensions in the final electroform, e.g. a hair-capture aperture in a shaving foil, the corresponding aperture in the mask has to be made somewhat larger than the required final dimensions. When making a shaving foil of 100 μm thickness, it is found that the mask apertures should be about 200 μm larger than the desired dimension of the final product. For example, to produce a shaving foil aperture of diameter 600 μm a mask aperture diameter of 800 μm would be required.

As for the apertures in the foil, their size depends on many factors, including their purpose (i.e. shaving or long-hair trimming); how many shaving heads (foils) are present on the razor; foil shape, size and thickness; and whether additional protection is available to limit skin penetration and prevent contact with the blades of the moving undercutter. Selection of aperture size is a compromise; the larger the hole, the more efficient it becomes in ‘capturing’ both hair (desirable) and skin (undesirable). Unfortunately, the presence of larger but necessarily fewer holes tends to result in a less efficient cutting performance because of a reduction in the number of aperture bars against which the cutting action occurs. Apertures should therefore be large to accommodate the longest hairs anticipated (say 400 to 600 microns for 24-hour hair growth), but not so large as to result in excessive skin penetration—particularly when foils are thin or worn—or to seriously reduce the number of available cutting events during each stroke of the cutter.

More realistically, maximum and minimum aperture dimensions of, say, 2.0×0.2 mm would not be unreasonable limits for an irregular shaving aperture pattern, tending towards a diameter of 0.6 mm for more uniform shapes.

For long-hair cutting apertures which are ‘protected’ to prevent excessive skin penetration, the requirement to restrict size is less critical. Probably the main consideration is to ensure that the aperture width (in the direction of cutter movement) is not so large as to seriously reduce the number of available aperture bars which, in conjunction with the cutter blades, provide the cutting action. Thus the minimum aperture dimension is likely to be similar to that for a normal shaving aperture, but apparent length could be in excess of 2.0 mm.

Referring to FIG. 24, a mask mandrel 222 is made from a suitable material such as stainless steel or plastics material.

When made of stainless steel, the surface should be polished to give a highly reflective fault-free surface for the application of electrophoretic photoresist.

An excimer laser, in conjunction with a six axis table, is then used to ablate the required pattern 231 of the mask into the photoresist (FIG. 25), resulting in the required mask pattern comprising exposed stainless steel, onto which a copper mask can be electroformed.

Where the mask is of plastics material, it is provided with a flash silver coating. The required pattern is produced by ablating the negative pattern from the silver to leave an electrically conducting silver pattern that is the same as the required mask.

Once the pattern has been etched, the mandrel is then supported on a base plate 241 as shown in FIG. 26 and the required mask 242 is then electroformed onto the etched surface of the mandrel. It will be appreciated that where the mandrel is of plastics material provided with a silver coating, the electroforming builds up on the patterned silver layer. Where the mandrel is stainless steel coated with electrophoretic photoresist, the mask pattern builds up on the exposed portions of the stainless steel surface. FIG. 26 also shows one end of the mask cut away at 243 to show the mask material built up upon the surface of the mandrel.

If the mandrel is of stainless steel, it is prepared for electroforming the mask by the following steps:

1.1 Lightly abrade with “Sturcal”™ chalk;

1.2 Rinse with deionized water;

1.3 Dip in cold acid cleaner for 30 seconds;

1.4 Rinse in deionized water for 30 seconds;

1.5 Dip in cold alkali cleaner for between 30 seconds and three minutes;

1.6 Rinse in deionized water for 30 seconds;

1.7 Dip in cold acid cleaner for 60 seconds;

1.8 Rinse in deionized water for 30 seconds.

If the mandrel is silver sprayed plastics material, no abrading with “Sturcal”™ is performed because the abrasion may disrupt the integrity of the ablated pattern. Care must be taken to ensure the silver coating is kept as free from contamination as possible because only mild cleaning is possible. This can be effected by the following steps:

2.1 Dip the mandrel in cold alkali cleaner for between 30 seconds and two minutes;

2.2 Rinse the mandrel in deionized water for 30 seconds;

2.3 Dip the mandrel in cold acid cleaner for 20 seconds;

2.4 Rinse the mandrel in deionized water for 30 seconds.

In both cases, benefit may be obtained by dipping the mandrel in 5% potassium dichromate solution. This treatment provides a passivation layer which facilitates separation of the electroform from the mandrel.

The mask 242 can then be electroformed as described below. Note that to ensure good metal distribution over the mandrel, it is beneficial to rotate the mandrel about the vertical axis during electroforming. The electroforming is performed by the following steps:

3.1 Electroform the pattern in copper from a dull acid electroplating solution comprising:

200 g/l copper (11) sulphate

10 g/l copper (11) chloride

30 ml/l sulphuric acid (SG 1.84) at room temperature with a Cathodic Current density of 55 mA/cm² for a time of 40 minutes;

3.2 Rinse the electroform in deionized water for 30 seconds;

3.3 Peel off the electroform from the mandrel.

Following preparation of the mask 242, the second polished mandrel 261 is prepared for the application of electrophoretic photoresist using the apparatus of FIG. 30, as described in the following steps:

4.1 Clean the mandrel 261 by rubbing with a slurry of “Sturcal”™ abrasive chalk;

4.2 Rinse with deionized water for 30 seconds.

4.3 Dip the mandrel in a hot alkaline cleaner (e.g. “Neutraclean”™) at 20-65° C. for 60-180 seconds, preferably 60° C. for 2 minutes.

4.4 Rinse the mandrel for 30 seconds.

4.5 Dip the mandrel in a cold acid cleaner for 15-180 seconds at 20-30° C., preferably 1 minute at 20° C.

4.6 Rinse the mandrel for 30 seconds.

4.7 Dip the mandrel in “Rinse Aid”™ at 25-40° C. for 60-180 seconds, preferably 28° C. for 1 minute.

4.8 Dip the mandrel in “Permeate Rinse” at 25-40° C. for 60-180 seconds, preferably 28° C. for 1 minute.

4.9 Soak the mandrel in “DV-191”™ electrophoretic photoresist 22 at 20-60° C., preferably at 25° C. for 60 seconds.

4.10 Apply a potential of 30V at 30 A between anodes 21 and the mandrel 261 as cathode for 45 seconds. (Note the current falls to about 0.0-0.2 A during this procedure.)

4.11 Dip the coated mandrel 261 in “Permeate Rinse”™ at 25-40° C. for 5-180 seconds, preferably 28° C. for 10 seconds.

4.12 Dip the mandrel in “Rinse Aid”™ at 25-40° C. for 5-180 seconds, preferably 25° C. for 10 seconds.

4.13 Rinse the mandrel in deionized water for 30 seconds.

4.14 Dry in an oven at 60-140° C. for 10-30 minutes, preferably 130° C. for 20 minutes.

4.15 Allow the mandrel to cool.

As shown in FIG. 31, the mask 242, manufactured according to the method described in FIGS. 24 to 26, is then mounted in the Perspex cap 4 and applied to the photoresist coated mandrel 261 before exposing the whole to ultraviolet light from source 31 in the light box 32, for sufficient time to thoroughly expose the photoresist to the UV radiation. The exposed photoresist is then developed. This process is performed according to the following steps:

5.1 Expose the coated mandrel 261 through mask 242 to UV radiation at 365 nm for sufficient time to achieve 1350 mJ/cm².

5.2 As shown in FIG. 32, develop the mandrel pattern in “Developer”™ 41 at 20-50° C., preferably 26° C. until the aperture pattern is just visible; note the time taken and continue the immersion for the same period.

5.3 Thoroughly rinse the mandrel and photoresist with deionized water.

5.4 Cure the photoresist at 160-200° C. for 20-30 minutes, preferably 180° C. for 25 minutes.

5.5 Allow to cool.

5.6 Alternatively to steps 5.4 and 5.5, the photoresist can be exposed to UV radiation for sufficient time to achieve sufficient energy densities to achieve further curing.

FIG. 27 shows the mask 242 with its foil aperture pattern 243. FIG. 28 shows the polished mandrel 261 coated with photoresist ready to receive the mask 242.

The mandrel 261 with its layer of developed photoresist is then prepared for electroforming as follows:

6.1 Clean the mandrel by rubbing with a slurry of abrasive chalk (e.g. “Sturcal”™).

6.2 Rinse the mandrel in deionized water for 30 seconds.

6.3 Soak the mandrel in cold acid cleaner as in step 4.5.

6.4 Rinse the mandrel in deionized water for 30 seconds.

6.5 Soak the mandrel in an alkaline cleaner as in step 1.5.

6.6 Rinse the mandrel for 30 seconds in deionized water.

6.7 Dip the mandrel in a cold acid cleaner as in step 4.5.

6.8 Rinse the mandrel in deionized water for 30 seconds.

The electroforming operation is then performed using the apparatus of FIG. 33, which shows the mandrel 261 as cathode on conductor rod 2, an anode 52, a heater 53 and a stirrer 54 all held in the electrolyte 51 contained in a tank 55.

Separation of the final electroform from the mandrel can be facilitated by the inclusion of a dipping step prior to the electroforming operation. The dipping step may be either chemical or electrochemical, in a solution of soluble dichromate salt or another suitable oxidising solution. Electroforming of the head is carried out in a nickel sulphamate bath at 60° C. with a cathodic current density of 30-60 mA/cm² for 90 to 180 minutes. Following the electroforming operation, a shaving foil 271 is generated on the mandrel as shown in FIG. 29. The electroform can then be removed from the mandrel and mounted onto an undercutter assembly to form a shaving system as hereinbefore described.

The passivation pre-treatment process facilitates the operation of removing the foil from the mandrel.

Benefit can be obtained by using a mandrel that has a coefficient of expansion which differs from that of the electroforming metal. Once the electroform has been produced, removal can be facilitated by exposing the electroform and mandrel, in situ, to either heat or cold, with the differing rates of expansion or contraction assisting in the parting of the electroform from the mandrel.

The thickness distribution can be modified and improved if desired by the use of robbers for equalising the current density distribution during electroforming. Alternatively, the mandrel can be screened by a suitable mask which will also equalize the current distribution during electroforming.

The success of three-dimensional electroforming is dependent on producing a suitable mandrel and on the production of a suitable mask. The mask will have bar width less than that of the final product. Moreover, the mask must be readily removable from the mandrel. For relatively simple three-dimensional shapes conventional photographic artwork could be used as the mask, but where the shape is complex, it is not possible to fold or bend this artwork to the required shape. In such cases the mask may be formed in a pliable metal, preferably copper, silver, gold, platinum, palladium, bismuth, cadmium, indium, lead, thallium, tin or zinc, and then bent, drawn or otherwise mechanically formed to the required shape. Provided a mask can be developed which is both accurate and impervious to ultraviolet light, other types of mask (e.g. paint or inks) could also be used, or a polyester mask could be produced by vacuum forming over a mandrel.

For use in the above methods, the following materials may be obtained from the sources indicated:

| | Material | Source |
|---|---|---|
| 1) | Neutraclean ™ | Shipley Co. |
| 2) | Rinse Aid ™ | LVH Coatings Ltd. |
| 3) | Permeate Rinse ™ | LVH Coatings Ltd. |
| 4) | DV-191 ™ | LVH Coatings Ltd. |
| 5) | Developer | LVH Coatings Ltd. |
| 6) | Sturcal ™ | Rhone Poulenc. |

Neutraclean™ is a trade name for essentially a solution of sodium metabisulphite in water.

Permeate Rinse™ is a trade name for an emulsion stabilizer containing lactic acid.

DV-191™ is a trade name for an electrophoretic photoresist containing 1-methoxy-2-propanol ethylene glycol n-hexyl ether, acetone and lactic acid.

“Developer” is the developer supplied by the manufacturer of DV-191™ for use with that photoresist.

Sturcal™ is a trade name for ultrafine precipitated calcium carbonate.

Various modifications and alternatives to the above-described devices and methods will naturally occur to those skilled in the art on the basis of the above discussion. All such modifications and alternatives falling within the scope of the following claims are the subject-matter of the present specification.

1. A shaving cutter (111) comprising a skin-engaging surface (116) having both a convex elliptic region (116a) and a hyperbolic region (116b).

2. A shaving cutter according to claim 1 wherein the elliptic region merges smoothly with the hyperbolic region.

3. A shaving cutter according to claim 2 wherein the elliptic region merges with the hyperbolic region along a parabolic transition region (117).

4. A shaving cutter according to any one of the preceding claims wherein at least one of the surface regions is perforate.

5. A shaving cutter according to any one of the preceding claims wherein a concave parabolic skirt region (114) depends from the hyperbolic region.

6. A shaving cutter according to any one of the preceding claims wherein a convex parabolic skirt region (115) depends from the elliptic region.

7. A shaving cutter according to claims 5 and 6 wherein the concave and convex skirt regions are concentric.

8. A shaving cutter according to any one of claims 5 to 7 wherein the or each skirt region is perforate.

9. A shaving cutter according to claim 8 wherein the or at least one skirt region is provided with elongate hair-capture slots.

10. A shaving cutter according to any one of the preceding claims further comprising a pair of convex elliptic end cheeks (112, 113) each merging smoothly with the elliptic and hyperbolic regions.

11. A shaving cutter comprising a skin-engaging surface having a convex first region which is parabolic or elliptic, a second region which is parabolic or hyperbolic and first and second convex elliptic end zones merging smoothly with the first and second regions.

12. A shaving cutter according to claim 11 or 12 wherein a skirt region depends from at least one of the first and second regions.

13. A shaving cutter according to claim 11 wherein at least one of the surface regions is perforate.

14. A shaving cutter according to claim 13 wherein the or at least one skirt region is perforate.

15. A shaving cutter according to claim 14 wherein the or each perforate skirt region has elongate hair-capture slots.

16. A shaving cutter comprising:
first curved skin-engaging surface region;
a second curved skin-engaging surface region; and
the second surface region merging seamlessly with the first surface region;
there existing a cross-sectional plane intersecting the first surface region along a first curved line on which the first surface region is concave with a first radius of curvature and intersecting the second surface region along a second curved line on which the second surface region is convex with a second radius of curvature larger than the first radius of curvature.

17. A shaving cutter comprising:
a first surface region having two orthogonal planes of curvature, and being concave in one plane;
a second surface region having two orthogonal planes of curvature, and being convex in both planes; and
the first surface region merging seamlessly with the second surface region.

18. A shaving system comprising an outer shaving cutter according to any one of the preceding claims; an undercutter conforming with the outer cutter and mounted for oscillatory movement beneath the outer cutter; and drive means for imparting said oscillatory movement to the undercutter.

19. A shaving system according to claim 18 wherein the outer cutter has an arcuate longitudinal centre line and the undercutter is correspondingly arcuate.

20. A shaving system according to claim 18 or 19 comprising at least first and second shaving units, at least one of which includes an outer cutter according to any one of claims 1 to 17 and a corresponding undercutter.

21. A shaving system according to claim 20 wherein at least two of the shaving units include an outer cutter according to any one of claims 1 to 17 and a corresponding undercutter.

22. A method of producing an electroformed shaving cutter in which:
a) a coating of electrophoretic photoresist is applied to a substrate having an electrically conductive surface by passing an electrical current therethrough, the surface having non-zero Gaussian curvature;
b) the photoresist is exposed to a suitable source of electromagnetic radiation through a mask whose shape conforms closely to that of the substrate;
c) the photoresist is developed; and
d) a metallic layer is electrodeposited onto the conductive surface regions of the substrate not coated with the photoresist.

23. A method according to claim 22, in which the substrate is of stainless steel.

24. A method according to claim 22 wherein the substrate is a body of plastics material having an electrically conductive surface coating.

25. A method according to any one of claims 22 to 24 in which the mask is provided with a plurality of non-elongate apertures.

26. A method according to claim 25 wherein the apertures each have a diameter in the range 600 to 800 microns.

27. A method according to any one of claims 22 to 26, wherein the mask is provided with a plurality of elongate apertures.

28. A method according to claim 27 wherein the apertures have a length of 400 to 2200 μm and a width of 400 to 800 μm.

29. A method according to any one of claims 22 to 28 in which the metallic layer has a varying relief pattern.

30. A method according to any one of claims 22 to 29, in which the mask is of ductile metal, e.g. copper.

31. A method according to any one of claims 22 to 30 in which the metallic layer is separated from the substrate by peeling or by dissolution of the substrate.

32. A method of manufacturing a three-dimensional electroforming mask for use in the method of any one of claims 22 to 31 comprising the step of forming an electrically conductive surface pattern by etching using a laser.

33. A method according to claim 32 in which the electrically conductive surface pattern is produced by coating an electrically conductive substrate with photoresist and selectively removing portions of the photoresist using the laser.

34. A method according to claim 32 in which the electrically conductive surface pattern is produced by coating an electrically insulating substrate with a conductive layer, and selectively removing portions of the conductive layer using the laser.

35. A method according to claim 34 wherein the coating is applied by electroforming to a desired thickness.

36. A method according to claim 34 or 35 in which the etching step is followed by a thickening step using electroforming.

37. A method according to claim 34, 35 or 36 in which the coating is removed from the substrate.
